(19) United States
(12) Patent Application Publication
(10) Pub. No.: US 2006/0203903 A1
(43) Pub. Date: Sep. 14, 2006

(54) Surveillance system having auto-adjustment functionality

(75) Inventors: Chi-Hsien Shih, Chung Ho City (TW); Cheng-Jyh Chang, Chang Ho City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AverMedia Technologies, Inc.

(21) Appl. No.: 11/263,214

(22) Filed: Oct. 31, 2005

(30) Foreign Application Priority Data
Mar. 14, 2005 (TW) 94107748

(51) Int. Cl. H04N 11/04; H04N 7/18; H04N 11/02; H04N 7/12; H04B 1/66

(52) U.S. Cl. 375/240.01; 348/155

(57) ABSTRACT

A surveillance system having auto-adjustment functionality is described. The surveillance system includes a motion detection module and a video processing module. The motion detection module detects real-time video data and determines whether the video data is in a motion status. When the real-time video data is in the motion status, the video processing module records the real-time video data into a storage medium with a first resolution. When the real-time video data is not in the motion status, the video processing module records the real-time video data into the storage medium with a second resolution.

### RELATED APPLICATIONS

The present application is based on, and claims priority from, Taiwan Application Serial Number 94107748, filed Mar. 14, 2005, the disclosure of which is hereby incorporated by reference herein in its entirety.

### BACKGROUND

1. Field of Invention

The present invention relates to a surveillance system and method. More particularly, the present invention relates to a surveillance system and method having auto-adjustment functionality.

2. Description of Related Art

When a conventional surveillance system is operated, a huge amount of video data is generated and recorded into a storage medium. Hence, motion detection is used to conserve space in the storage medium by which video data is recorded into the storage medium only when motion is detected in the image by the surveillance system. Otherwise, video data is not recorded and the surveillance system only displays the detected image. In this way, the video image recorded before the occurrence of the motion will be completely omitted, and many clues may be missed if the video image records a crime or accident.

The foregoing problem can of course be resolved by continuously recording all of the video imagery detected by the surveillance system, but again, a huge amount of video data is obtained and only a small portion of the video data is really helpful. Thus, storage medium space is greatly wasted and the time spent for searching out specific video data is increased.

Therefore, a surveillance system and method having auto-adjustment functionality, which is able to conserve storage medium space and record relevant detected imagery, is needed to solve the foregoing problems.

### SUMMARY

It is therefore an objective of the present invention to provide a surveillance system and method having auto-adjustment functionality, wherein when there is no motion detected in the monitored image, the surveillance system records a video data with a lower resolution, and when there is a motion detected in the monitored image, the surveillance system records the video data with a higher resolution.

It is another objective of the present invention to provide a surveillance system and method having auto-adjustment functionality, wherein when there is no motion detected in the monitored image, the surveillance system records a video data with a lower frame rate, and when there is a motion detected in the monitored image, the surveillance system records the video data with a higher frame rate.

It is still another objective of the present invention to provide a surveillance system and method having auto-adjustment functionality, which is able to conserve storage medium space and record relevant detected imagery.

According to the foregoing objectives of the invention, a surveillance system having auto-adjustment functionality is provided. In an embodiment of the present invention, the surveillance system includes a motion detection module and a video processing module.

The motion detection module is used to detect a real-time video data for determining whether the real-time video data is in a motion status. When the real-time video data is in the motion status, the video processing module records the real-time video data into a storage medium with a first resolution. When the real-time video data is not in the motion status, the video processing module records the real-time video data into the storage medium with a second resolution. The first resolution is higher than the second resolution in general.

According to the foregoing objectives of the invention, a surveillance system having auto-adjustment function is provided. In an embodiment of the present invention, the surveillance system includes a motion detection module and a video processing module.

The motion detection is used to detect a real-time video data for determining whether the real-time video data is in a motion status. When the real-time video data is in the motion status, the video processing module records the real-time video data into a storage medium with a first frame rate. When the real-time video data is not in the motion status, the video processing module records the real-time video data into the storage medium with a second frame rate. The first frame rate is higher than the second frame rate in general.

According to the foregoing objectives of the invention, a surveillance method having auto-adjustment functionality is further provided. In an embodiment of the present invention, the surveillance method includes the following steps. First, a real-time video data is detected for determining whether the real-time video data is in a motion status. When the real-time video data is in the motion status, the real-time video data is recorded into a storage medium with a first resolution. When the real-time video data is not in the motion status, the real-time video data is recorded into the storage medium with a second resolution. The first frame rate is higher than the second frame rate in general.

According to the foregoing objectives of the invention, a surveillance method having auto-adjustment function is provided. In an embodiment of the present invention, the surveillance method includes following steps. First, a real-time video data is detected for determining whether the real-time video data is in a motion status. When the real-time video data is in the motion status, the real-time video data is recorded into a storage medium with a first frame rate. When the real-time video data is not in the motion status, the real-time video data is recorded into the storage medium with a second frame rate. The first frame rate is higher than the second frame rate in general.

The present invention has at least the following advantages, of which each of the embodiments of the present invention may include one or more of these advantages. When there is no motion detected in the monitored image, the surveillance system can record the video data with a lower resolution or frame rate, and when there is a motion detected in the monitored image, the surveillance system can record the video data with a higher resolution or frame rate. The surveillance system and method of the present invention is able to conserve storage medium space and record the relevant monitored image.

### BRIEF DESCRIPTION OF THE DRAWINGS

These and other features, aspects and advantages of the present invention will become better understood with regard to the following description, appended claims and accompanying drawings, where:

FIG. 1 is the block diagram of an embodiment of the present invention;

FIG. 2 is the recording time section diagram of the surveillance system according to an embodiment of the present invention;

FIG. 3 is a flow chart of the surveillance method according to an embodiment of the present invention; and

FIG. 4 is a flow chart of the surveillance method according to an embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

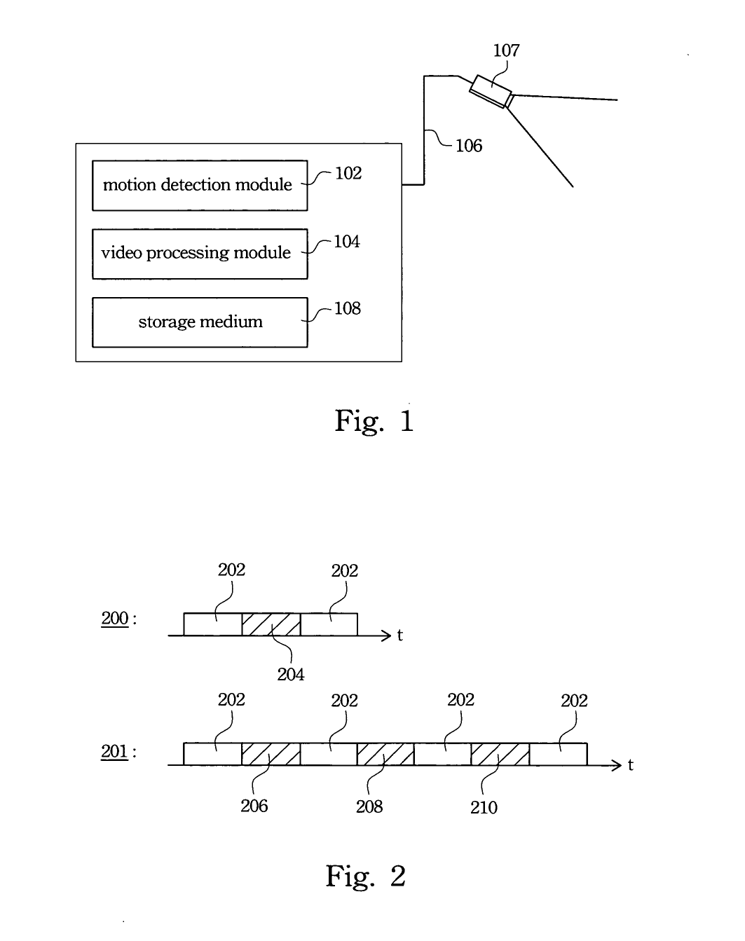

FIG. 1 shows a block diagram of an embodiment of the present invention, in which a surveillance system 100 having auto-adjustment functionality includes a motion detection module 102 and a video processing module 104. A lens 107 is used to monitor a location for generating a real-time video data 106. The motion detection module 102 is used to detect the real-time video data 106 for determining whether the real-time video data 106 is in a motion status.

When the real-time video data 106 is in the motion status, the video processing module 104 records the real-time video data 106 into a storage medium 108 with a first resolution. When the real-time video data 106 is not in the motion status, the video processing module 104 records the real-time video data 106 into the storage medium 108 with a second resolution. The first resolution is higher than the second resolution in general.

In other words, the surveillance system 100 does not always record the real-time video data 106 with a high resolution. The real-time video data 106 can be recorded with the high resolution only when a motion is detected in the monitored image; otherwise, the real-time video data 106 is recorded with a low resolution. Thus, the space of the storage medium 108 can be conserved.

In an embodiment, the video processing module 104 compresses the real-time video data 106 with a first compression rate for obtaining the first resolution, and compresses the real-time video data 106 with a second compression rate for obtaining the second resolution. The first compression rate is lower than the second compression rate in general.

In other words, when there no motion is detected by the surveillance system 100, the surveillance system 100 compresses the real-time video data 106 with a higher compression rate. When there is a motion detected by the surveillance system 100, the surveillance system 100 compresses the real-time video data 106 with a lower compression rate. The higher compression rate results in a lower image quality, and the lower compression rate results in a higher image quality; therefore, the first resolution is higher than the second resolution. The surveillance system 100 of the present invention is able to automatically determine the motion status and then automatically adjust the compression rate. Thus, the space of the storage medium 108 can be conserved and the whole real-time video data 106 can be completely recorded also.

In another embodiment, the video processing module 104 compresses the real-time video data 106 with a first frame size for obtaining the first resolution, and compresses the real-time video data 106 with a second frame size for obtaining the second resolution. The first frame size is larger than the second frame size in general.

For example, when there is no motion detected by the surveillance system 100, the video processing module 104 records the real-time video data 106 with the resolution of 352×288, and when there is a motion detected by the surveillance system 100, the video processing module 104 records the real-time video data 106 with the resolution of 640×480. Thus, a clearer image can be recorded when the surveillance system 100 detects the motion, and a less clear image can be recorded for conserving the storage medium 108 space when there is no motion detected by the surveillance system 100. The storage medium 108 may be a hard disk. The surveillance system 100 of the present invention is able to automatically determine the motion status and then automatically adjust the image size. Thus, the space of the storage medium 108 can be conserved and the whole real-time video data 106 can be completely recorded.

In another embodiment, the video processing module 104 records the real-time video data 106 into the storage medium 108 with a first frame rate when the real-time video data 106 is in a motion status. The video processing module 104 records the real-time video data 106 into the storage medium 108 with a second frame rate when the real-time video data 106 is not in the motion status. The first frame rate is higher than the second frame rate in general.

For example, when there is no motion detected by the motion detection module 102, the surveillance system 100 records the real-time video data 106 with a rate of 1 frame per second for conserving the storage medium 108 space. When a motion is detected by the motion detection module 102, the surveillance system 100 records the real-time video data 106 with a rate of 30 frames per second for recording a specific image at this moment. The surveillance system 100 of the present invention is able to automatically determine the motion status and then automatically adjust the frame rate. Thus, the space of the storage medium 108 can be conserved and the whole real-time video data 106 can be completely recorded.

FIG. 2 shows a recording time sectional diagram of the surveillance system according to an embodiment of the present invention. In a recording mode 200, a time section 202 indicates that the surveillance system 100 detects no motion; therefore, the recording operation of the surveillance system 100 is with a lower frame rate, a lower resolution, a higher compression rate or a smaller image size within the time section 202. A time section 204 indicates that the surveillance system 100 detects a motion; therefore, the reco ″ rg tion of the surveillance system 100 is with a higher frame rate, a higher resolution, a lower compression rate or a larger image size within the time section 204.

In a recording mode 201, a time section 202 indicates that the surveillance system 100 detects no motion; therefore, the recording operation of the surveillance system 100 is with a lower frame rate, a lower resolution, a higher compression rate or a smaller image size within the time section 202. Time sections 206, 208 and 210 respectively indicate that the surveillance system 100 detects a motion of different motion ranges; therefore, the recording operation of the surveillance system 100 is with different frame rates, resolutions, compression rates or image sizes within the time sections 206, 208 and 210 respectively for adapting to different motion ranges. The detection of the motion range and the adjustment of the image can be accomplished with any hardware or software.

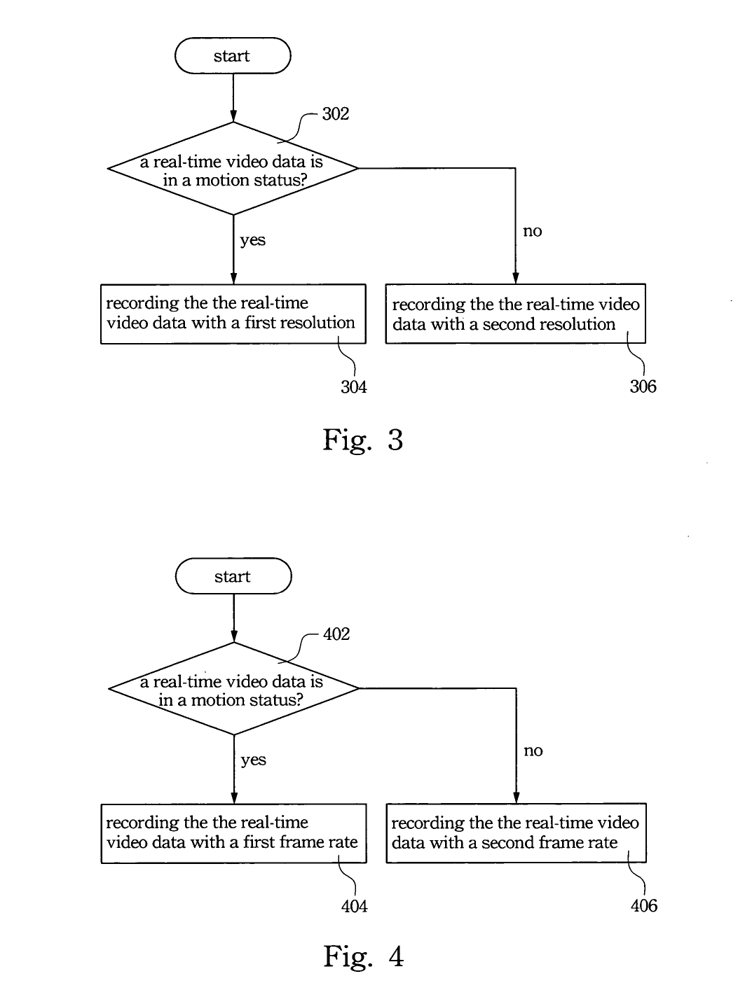

A surveillance method having auto-adjustment functionality is further provided by the present invention. FIG. 3 shows a flow chart of the surveillance method according to an embodiment of the present invention comprising the following steps. In the step 302, a real-time video data is detected for determining whether the real-time video data is in a motion status. When the real-time video data is in the motion status, the real-time video data is recorded into a storage medium with a first resolution in the step 304. When the real-time video data is not in the motion status, the real-time video data is recorded into a storage medium with a second resolution in the step 306. The motion detection is continuously repeated in the recording operation, and the first resolution is higher than the second resolution in general.

Another surveillance method having auto-adjustment functionality is further provided by the present invention. FIG. 4 shows a flow chart of the surveillance method according to another embodiment of the present invention comprising the following steps. In the step 402, a real-time video data is detected for determining whether the real-time video data is in a motion status. When the real-time video data is in the motion status, the real-time video data is recorded into a storage medium with a first frame rate in the step 404. When the real-time video data is not in the motion status, the real-time video data is recorded into a storage medium with a second frame rate in the step 406. The first frame rate is higher than the second resolution in general. Structural details of the embodiments shown in FIG. 3 and FIG. 4 are described in the embodiments shown in FIG. 1 and FIG. 2.

The present invention has at least the following advantages, wherein each of the embodiments of the present invention may have one or more of the advantages. The surveillance system and method of the present invention is able to record a real-time video data with a lower resolution or frame rate when there no motion in the real-time video data is detected, and the surveillance system and method is able to record the real-time video data with a higher resolution or frame rate when a motion in the real-time video data is detected. Thus, storage medium space can be conserved and the relevant image in the real-time video data can be completely recorded.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A surveillance system having auto-adjustment functionality, the system comprising:
a motion detection module used to detect a real-time video data for determining whether the real-time data is in a motion status; and
a video processing module, wherein the video processing module records the real-time video data into a storage medium with a first resolution when the real-time video data is in the motion status, and the video processing module records the real-time video data into the storage medium with a second resolution when the real-time video data is not in the motion status, wherein the first resolution is higher than the second resolution.

2. The surveillance system as claimed in claim 1, wherein the video processing module compresses the real-time video data with a first compression rate for obtaining the first resolution, and the video processing module compresses the real-time video data with a second compression rate for obtaining the second resolution, wherein the first compression rate is lower than the second compression rate.

3. The surveillance system as claimed in claim 1, wherein the video processing module compresses the real-time video data with a first frame size for obtaining the first resolution, and the video processing module compresses the real-time video data with a second frame size for obtaining the second resolution, wherein the first frame size is larger than the second frame size.

4. The surveillance system as claimed in claim 1, wherein the storage medium comprises a hard disk.

5. A surveillance system having auto-adjustment functionality, the system comprising:
a motion detection module used to detect a real-time video data for determining whether the real-time data is in a motion status; and
a video processing module, wherein the video processing module records the real-time video data into a storage medium with a first frame rate when the real-time video data is in the motion status, and the video processing module records the real-time video data into the storage medium with a second frame rate when the real-time video data is not in the motion status, wherein the first frame rate is higher than the second frame rate.

6. The surveillance system as claimed in claim 5, wherein the storage medium comprises a hard disk.

7. A surveillance method having auto-adjustment functionality, the method comprising:
detecting a real-time video data for determining whether the real-time video data is in a motion status;
recording the real-time video data into a storage medium with a first resolution when the real-time video data is in the motion status; and
recording the real-time video data into the storage medium with a second resolution when the real-time video data is not in the motion status,
wherein the first resolution is higher than the second resolution.

8. The surveillance method as claimed in claim 7, wherein the first resolution is obtained by compressing the real-time video data with a first compression rate, and the second resolution is obtained by compressing the real-time video data with a second compression rate, wherein the first compression rate is lower than the second compression rate.

9. The surveillance method as claimed in claim 7, wherein the first resolution is obtained by compressing the real-time video data with a first frame size, and the second resolution is obtained by compressing the real-time video data with a second frame size, wherein the first frame size is larger than the second frame size.

10. The surveillance method as claimed in claim 7, wherein the storage medium comprises a hard disk.

11. A surveillance method having auto-adjustment functionality, the method comprising:
detecting a real-time video data for determining whether the real-time video data is in a motion status;
recording the real-time video data into a storage medium with a first frame rate when the real-time video data is in the motion status; and
recording the real-time video data into the storage medium with a second frame rate when the real-time video data is not in the motion status,
wherein the first frame rate is higher than the second frame rate.

12. The surveillance method as claimed in claim 11, wherein the storage medium comprises a hard disk.
